(19) United States
(12) Patent Application Publication
(10) Pub. No.: US 2023/0009357 A1
(43) Pub. Date: Jan. 12, 2023

(54) METHOD OF PRODUCING SEPARATOR FOR LITHIUM SECONDARY BATTERY AND LITHIUM SECONDARY BATTERY INCLUDING SEPARATOR

(71) Applicants: Hyundai Motor Company, Seoul (KR); Kia Corporation, Seoul (KR)

(72) Inventors: Sang Mok PARK, Gwangju-si (KR); Tae Hyung NAM, Anyang-si (KR)

(73) Assignees: Hyundai Motor Company, Seoul (KR); Kia Corporation, Seoul (KR)

(21) Appl. No.: 17/728,439

(22) Filed: Apr. 25, 2022

(30) Foreign Application Priority Data
Jul. 8, 2021 (KR) 10-2021-0089978

(51) Int. Cl. H01M 50/449; H01M 50/463; H01M 10/0525; H01M 50/489; H01M 10/04; H01M 50/434

(52) U.S. Cl. CPC H01M 50/449; H01M 50/463; H01M 10/0525; H01M 50/489; H01M 10/0468; H01M 50/434

(57) ABSTRACT

A method of producing a separator for a lithium secondary battery, the separator being interposed between a positive electrode and a negative electrode of the lithium secondary battery, includes: preparing a separator substrate; forming a ceramic coating layer by applying a first coating solution containing a ceramic material to a surface of the separator substrate; and forming a reaction layer that scatters X-rays, by applying a second coating solution containing a metal compound to an edge portion of an upper surface of the ceramic coating layer that is not in contact with the positive electrode and the negative electrode.

### CROSS REFERENCE TO RELATED APPLICATION

The present application claims priority to Korean Patent Application No. 10-2021-0089978, filed on Jul. 8, 2021, the entire contents of which is incorporated herein for all purposes by this reference.

### BACKGROUND OF THE PRESENT DISCLOSURE

### Field of the Present Disclosure

The present disclosure relates to a method of producing a separator interposed between a positive electrode and a negative electrode of a lithium secondary battery. More particularly, the present disclosure relates to a method of producing separators for lithium secondary batteries, the method allowing defective separators to be identified in a non-destructive manner during or after formation of the lithium secondary batteries.

### Description of Related Art

Secondary batteries have been used as large-capacity power storage devices for applications in electric vehicles, large-capacity energy storage systems, and the like as well as small-capacity high-performance energy sources for applications in mobile electronic devices such as mobile phones, camcorders, and laptop computers. To meet the need of persistent downsizing and long-term continuous use of portable electronic devices, aside from research into lightweight low-power parts for the electronic devices, the development of secondary batteries that are reduced in size and increased in capacity is required.

Meanwhile, a lithium secondary battery is a device that converts chemical energy into electrical energy via lithium ion intercalation/deintercalation at a negative electrode and a positive electrode, and a separator interposed between the negative electrode and the positive electrode plays a critical role in the safety of the lithium secondary battery.

The separator is interposed between the negative electrode and the positive electrode to prevent physical contact between the positive electrode and the negative electrode. The separator is vulnerable to high temperatures because it is typically made of polypropylene (PP)-, polyethylene (PE)-, or polyolefin-based materials. For the present reason, the separator may easily shrink when heated, resulting in a short circuit between the negative electrode and the positive electrode. Moreover, lithium dendrites formed when metallic lithium is deposited on the negative electrode may permeate into the separator and this also may cause a short circuit. Such short circuits may lead to generation of overcurrent caused by side reactions, and thermal runaway chain reactions inside the battery, resulting in explosion of the battery.

Conventionally, an electric method (leakage current measurement, resistance measurement, and the like) is used to determine whether lithium secondary batteries are defective, to sort out defective batteries. However, the present method is limited in accurately identifying a defective lithium secondary battery because there is likelihood that a defective lithium secondary battery is erroneously determined to be normal as long as the negative electrode is not in contact with the positive electrode even in the case where the separator is misaligned or damaged.

For the present reason, to determine whether a separator of a manufactured lithium secondary battery is defective, cells in the battery are disassembled to investigate whether the separator is properly positioned or deformed through testing.

On the other hand, as a non-destructive inspection method, an attempt to investigate whether a lithium secondary battery is defective using equipment such as CT equipment has been made. However, inspection of separators currently used in lithium secondary batteries is challenging due to the following limitations. This will be described with reference to FIG. 1.

First, the thickness of a commercially available separator is about 10 to 18 μm, whereas the resolution of CT equipment is about 20 to 30 μm. This makes it difficult to detect the shape of the separator having a thickness smaller than the resolution.

Furthermore, when a high-density material and a low-density material coexist, it is difficult to secure a contrast to noise ratio (CNR) for the low-density material. In a lithium secondary battery, the density of a separator substrate is 0.8 to 0.9 g/cm³, which is about ⅓ of the density (2.7 g/cm³) of an aluminum pouch serving as a case. High-density materials (pouch, positive electrode, and negative electrode) that exist around the relatively low-density separator scatter X-rays in all directions, so that the CNR of the low-density separator further decreases. Even when the separator is coated with a ceramic material such as alumina to increase the rigidity thereof, the density of the separator with a coating layer is still limited to 0.8 to 0.9 g/cm³ due to high porosity of the coating layer.

Finally, the separator is surrounded by electrolyte inside the pouch, and the density (about 1.0 to 1.5 g/cm³) of the electrolyte is comparable to or greater than that of the separator, so it is difficult to distinguish the shape of the separator from that of the electrolyte on a CT image.

That is, as illustrated in a CT image of FIG. 1, it is difficult to clearly identify the shape of the separator.

Due to the above limitations, the use of the non-destructive inspection method is not very effective. This calls for development of a technology that can accurately detect the shape of a separator in a non-destructive manner.

The foregoing is intended merely to aid in the understanding of the background of the present disclosure, and is not intended to mean that the present disclosure falls within the purview of the related art which is already known to those skilled in the art.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of producing a separator, the method being configured for detecting the position of the separator in a non-destructive manner. The separator for a lithium secondary battery according to an exemplary embodiment of the present disclosure is produced by the following steps: a coating layer including a ceramic material is formed to improve the rigidity of the separator; and then a reaction layer including a metal compound is formed on an edge portion of the coating layer, i.e., on an upper surface of the coating layer, which is not in contact with a negative electrode and a positive electrode. With the reaction layer including a high-density metal compound, it is possible to obtain a CT image of the separator which is remarkably clear compared to that of a conventional separator.

In an aspect of the present disclosure, there is provided a method of producing a separator for a lithium secondary battery, the separator being interposed between a positive electrode and a negative electrode of the lithium secondary battery, the method including: preparing a separator substrate; forming a ceramic coating layer by applying a first coating solution including a ceramic material to a surface of the separator substrate; and forming a reaction layer that scatters X-rays, by applying a second coating solution including a metal compound to an edge portion of an upper surface of the ceramic coating layer which is not in contact with the positive electrode and the negative electrode.

The metal compound contained in the second coating solution may be at least one metal oxide formed by a reaction between oxygen and at least one metal selected from the group consisting of Co, Ni, Cu, Zn, Pd, Ga, Sn, Ag, Cd, Ti, Cr, Mo, W, Nb, Zr, Y, Ce, Ta, and Hf, at least one metal nitride formed by a reaction between nitrogen and at least one metal selected from the group consisting of Ti, Nb, Ta, V, Ga, and In, or at least one metal sulfide or metal sulfate formed by a reaction between sulfur or sulfuric acid and at least one metal selected from the group consisting of Mo, Cu, W, Ti, In, Bi, Cd, Cs, Ba, and Fe.

The metal compound may have a density of equal to or greater than 4.5 g/cm³.

The reaction layer may have a density of 2.0 to 5.6 g/cm³.

The reaction layer may have a thickness of 5 to 30 μm.

The second coating solution may be applied so that the reaction layer has a linear, X-shaped, or cross (+)-shaped pattern.

According to various aspects of the present disclosure, there is provided a lithium secondary battery including: a positive electrode; a negative electrode; and a separator interposed between the positive electrode and the negative electrode and including a coating layer including a metal compound, the coating layer scattering X-rays and being formed on an edge portion of the separator which is not in contact with the positive electrode and the negative electrode.

The coating layer may be formed on an upper surface or a side surface of the separator.

When a lithium secondary battery is manufactured using the separator produced by the method according to an exemplary embodiment of the present disclosure, it is possible to scan the position of the separator using CT equipment, detecting the position of the separator in a non-destructive manner without requiring a disassembly work.

Furthermore, it is possible to simply perform a total inspection of lithium secondary batteries during a manufacturing process, so that, a defective lithium secondary battery in which a separator is in an incorrect position may be discarded or reassembled, minimizing process defects.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a CT image illustrating a typical lithium secondary battery;

FIG. 2 is a flowchart illustrating a method of producing a separator for a lithium secondary battery according to various exemplary embodiments of the present disclosure;

FIG. 3 is a sectional view exemplarily illustrating a separator produced by the method of producing the separator for the lithium secondary battery according to the exemplary embodiment of the present disclosure;

FIG. 4 is a view exemplarily illustrating a separator in which a reaction layer is formed on an edge portion of a ceramic coating layer;

FIG. 5 is a view exemplarily illustrating a separator in which a reaction layer is formed on a part of the edge portion of a separator substrate;

FIG. 6 is a view exemplarily illustrating patterns of a coating layer; and

FIG. 7 is a view comparing a CT image of Example with a CT image of Comparative Example.

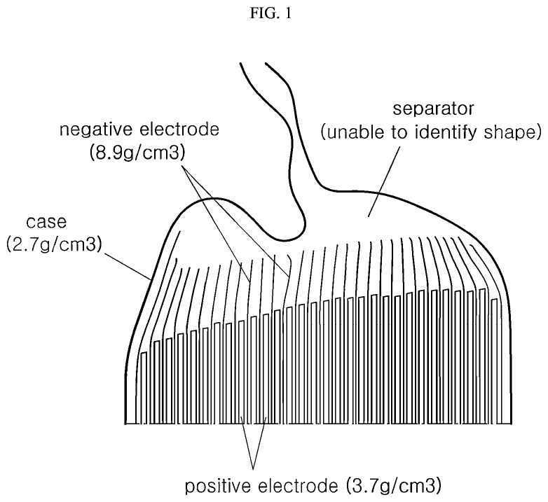

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a specific exemplary embodiment for solving the above-described objective and problems will be described in detail with reference to the accompanying drawings. As used herein, the terms “separator substrate” and “separator” are used interchangeably. The separator substrate refers to a porous membrane provided as a base material for producing a separator according to an exemplary embodiment of the present disclosure, and the separator refers to a separator produced by a method of producing a separator according to an exemplary embodiment of the present disclosure. In the following description, it is to be noted that, when the functions of conventional elements and the detailed description of elements related with the present disclosure may make the gist of the present disclosure unclear, a detailed description of those elements will be omitted. Furthermore, the present disclosure is not limited to the specific exemplary embodiment set forth herein, and those skilled in the art will appreciate that the present disclosure can be embodied in many alternate forms.

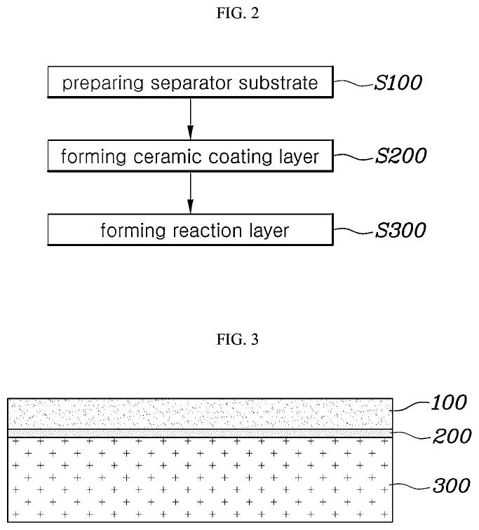

FIG. 2 is a flowchart illustrating a method of producing a separator for a lithium secondary battery according to various exemplary embodiments of the present disclosure, and FIG. 3 is a sectional view exemplarily illustrating a separator produced by the method of producing the separator for the lithium secondary battery according to the exemplary embodiment of the present disclosure. To produce a separator by the method of producing the separator according to an exemplary embodiment of the present disclosure, first, a separator substrate 100 is prepared (S100). The separator substrate 100 is preferably made of a material which may be typically used as the separator substrate 100, such as a polyethylene (PE)-, polyethylene (PE)/polypropylene (PP)-, or polyolefin-based microporous membrane, a polyvinylidene fluoride (PVDF) porous membrane, and the like. Thereafter, a first coating solution including a ceramic material is applied to a surface of the prepared separator substrate 100 and then dried to form a ceramic coating layer 200 (S200). Forming the ceramic coating layer 200 is not only to increase mechanical strength of the separator substrate 100, but also to improve thermal properties and ionic conductivity of the separator substrate 100. As the ceramic material contained in the first coating solution, SiO₂, TiO₂, Al₂O₃, or ZrO₂ may be used. As a binder, a PVDF-based binder, a styrene-butadiene rubber (SBR)/carboxymethyl cellulose (CMC)-based binder, a polytetrafluoroethylene (PTFE)-based binder, a polyolefin-based binder, a polyimide-based binder, a polyurethane-based binder, or a polyester-based binder may be used. After the ceramic coating layer 200 is formed, a second coating solution is applied to an edge portion of an upper surface of the ceramic coating layer 200 which is not in contact with a positive electrode and a negative electrode to form a reaction layer 300 that scatters X-rays (S300). Here, the second coating solution includes a metal compound, and may further include a binder and a solvent. As the binder, CMC, SBR, polyacrylic acid (PAA), PVDF, polyvinyl alcohol (PVA), or polyimide (PI) may be used. As the solvent, alcohol, distilled water, N-methylpyrrolidone (NMP), dimethylformamide (DMF), dimethylaniline (DMA), or tetrahydrofurane (THF) may be used. The metal compound contained in the second coating solution may be at least one metal oxide formed by a reaction between oxygen and at least one metal selected from the group consisting of Co, Ni, Cu, Zn, Pd, Ga, Sn, Ag, Cd, Ti, Cr, Mo, W, Nb, Zr, Y, Ce, Ta, and Hf, at least one metal nitride formed by a reaction between nitrogen and at least one metal selected from the group consisting of Ti, Nb, Ta, V, Ga, and In, or at least one metal sulfide or metal sulfate formed by a reaction between sulfur or sulfuric acid and at least one metal selected from the group consisting of Mo, Cu, W, Ti, In, Bi, Cd, Cs, Ba, and Fe.

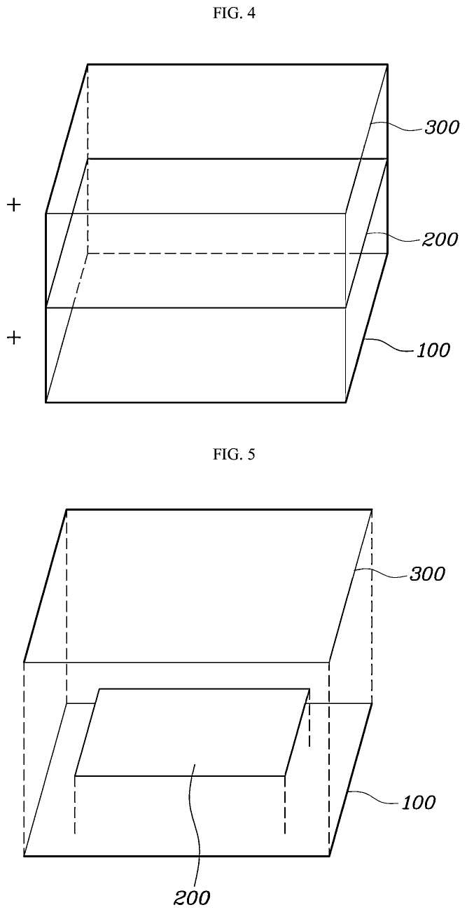

According to the method of producing the separator for the lithium secondary battery according to the exemplary embodiment of the present disclosure, the reaction layer 300 is formed on a portion of the ceramic coating layer 200. However, as another exemplary embodiment of the present disclosure, the reactive layer may be formed on an edge portion of the separator substrate 100 which is not in contact with the positive electrode and the negative electrode. FIG. 4 is a view exemplarily illustrating a separator in which a reaction layer is formed on an edge portion of a ceramic coating layer, and FIG. 5 is a view exemplarily illustrating a separator in which a reaction layer is formed on a part of an edge portion of a separator substrate. Because physical contact between the positive electrode and the negative electrode is blocked by the separator, each of the positive electrode and the negative electrode has an area smaller than that of the separator substrate 100. Therefore, a part of the separator substrate 100 or a part of the ceramic coating layer 200 formed on an upper surface of the separator substrate 100 is not in contact with the positive electrode and the negative electrode. Accordingly, the reaction layer 300 may be formed on the upper surface of the separator substrate 100 or the upper surface of the ceramic coating layer 200 which not in contact with the positive electrode and the negative electrode. This is to minimize the amount of decrease in energy density of the lithium secondary battery because the energy density decreases compared to a conventional lithium secondary battery as the reaction layer 300 is formed. Forming the reaction layer 300 on the upper surface of the separator substrate 100 or the ceramic coating layer 200 which is not in contact with the positive electrode and the negative electrode provides an advantage in that it is possible to minimize a reduction in capacity of the lithium secondary battery relative to volume thereof and a reduction in capacity of the lithium secondary battery relative to weight thereof due to the formation of the reaction layer 300.

Meanwhile, the metal compound contained in the second coating solution has a density of equal to or greater than 4.5 g/cm³. This is because even when the separator substrate 100 is coated with the ceramic coating layer 200, the density thereof is still 0.8 to 0.9 g/cm³, so a high-density metal compound is required to further increase the density.

The density of an electrolyte surrounding the separator substrate 100 is about 1.0 to 1.5 g/cm³. Therefore, for the reaction layer 300 to have excellent visibility on a CT image, the density of the reaction layer 300 is at least 2.0 g/cm3. Furthermore, as illustrated in FIG. 2, the positive electrode exhibits the best visibility on a CT image. Therefore, the density of the reaction layer 300 is adjusted to about 5.6 g/cm³, which is about 1.5 times the approximate density (3.7 g/cm³) of the positive electrode.

However, the density of the positive electrode is exemplary because it is a variable factor depending on which material is used, and the density of the reaction layer 300 may be readily varied by those skilled in the art depending on the density of the positive electrode.

Meanwhile, the thickness of the reaction layer 300 may be 5 to 30 μm. When the density of the reaction layer 300 is sufficiently high, high visibility is ensured even when the thickness of the reaction layer 300 is lower than the resolution of CT equipment. However, when the density of the reaction layer 300 is 2.0 g/cm³, the thickness of the reaction layer 300 is equal to or greater than the resolution of the CT equipment. In general, the resolution of the CT equipment is about 25 μm. Therefore, when the density of the reaction layer 300 is 2.0 g/cm³, the thickness of the reaction layer 300 is equal to or greater than 25 μm. The thickness of the reaction layer 300 is exemplary, and may be readily varied by those skilled in the art depending on the resolution of the CT equipment used.

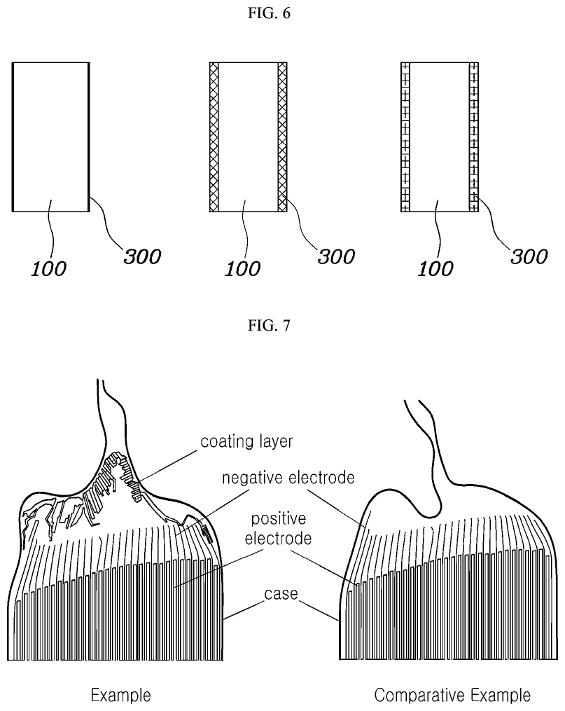

Meanwhile, referring to FIG. 6, the reaction layer 300 may have a linear, X-shaped, or cross (+)-shaped pattern. When the visibility of the reaction layer 300 is high, this makes it easy to determine whether the separator is defective. However, using a high-density metal compound to improve the visibility of the reaction layer 300 is not preferable in terms of reducing the capacity of the lithium secondary battery relative to the weight thereof. Also, forming a wide reaction layer 300 is not preferable in terms of reducing the capacity lithium secondary battery relative to the volume thereof. To determine whether the separator is defective, it is sufficient to detect the end portion position of the separator. Therefore, it is not necessary to form the reaction layer 300 on the entire separator substrate 100 or the entire ceramic coating layer 200, but it is sufficient to form the reaction layer 300 on a part of the separator substrate 100 or a part of the upper surface of the ceramic coating layer 200. The pattern of the reactive layer 300 is exemplary, and may be readily varied by those skilled in the art.

In terms of accurately detecting the end portion position of the separator, the smaller the width of the reaction layer 300, the more advantageous it is. However, the CT equipment has a limited resolution, so that the width of the reaction layer 300 is set to a value equal to or greater than the resolution of the CT equipment used. When the width of the pattern of the reaction layer 300 is comparable to the resolution, the visibility of the reaction layer 300 is increased and the amount of reduction in capacity relative to volume is not significant.

On the other hand, the reaction layer 300 may be not only formed on upper and lower surfaces of the separator substrate 100, but also formed on a side surface of the separator substrate 100, i.e., a cut surface of the separator substrate 100. However, considering the thickness of the separator substrate 100, when the reaction layer 300 is formed on the side surface of the separator substrate 100, a metal compound having a sufficiently high density is used.

FIG. 7 is a view comparing a CT image of a lithium secondary battery of Example produced by the method of producing the separator for the lithium secondary battery according to the exemplary embodiment of the present disclosure with a CT image of a typical lithium secondary battery of Comparative Example.

In the case of Example, a separator was prepared so that a reaction layer was formed by use of a second coating solution including 96 wt % of cobalt oxide, 2% of PVDF, and 2% of carbon black under conditions in which the thickness of the reaction layer was 5 to 10 μm and the width thereof was 1 to 3 mm. A lithium secondary battery was produced by use of the thus prepared separator.

In the case of Comparative Example, a lithium secondary battery was produced by use of a separator prepared without the use of the above second coating solution.

As illustrated in FIG. 7, in the case of Example, the reaction layer formed at the end of the separator exhibits high visibility, so it is possible clearly identify the position of the separator. This makes it possible to identify a defective lithium secondary battery in which a separator is in an incorrect position.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of producing a separator for a lithium secondary battery, the separator being interposed between a positive electrode and a negative electrode of the lithium secondary battery, the method comprising:
preparing a separator substrate;
forming a ceramic coating layer by applying a first coating solution containing a ceramic material to a surface of the separator substrate; and
forming a reaction layer that scatters X-rays, by applying a second coating solution containing a metal compound to an edge portion of an upper surface of the ceramic coating layer which is not in contact with the positive electrode and the negative electrode.

2. The method of claim 1, wherein the metal compound contained in the second coating solution is at least one metal oxide formed by a reaction between oxygen and at least one metal selected from the group consisting of Co, Ni, Cu, Zn, Pd, Ga, Sn, Ag, Cd, Ti, Cr, Mo, W, Nb, Zr, Y, Ce, Ta, and Hf, at least one metal nitride formed by a reaction between nitrogen and at least one metal selected from the group consisting of Ti, Nb, Ta, V, Ga, and In, or at least one metal sulfide or metal sulfate formed by a reaction between sulfur or sulfuric acid and at least one metal selected from the group consisting of Mo, Cu, W, Ti, In, Bi, Cd, Cs, Ba, and Fe.

3. The method of claim 2, wherein the metal compound has a density equal to or greater than 4.5 g/cm³.

4. The method of claim 1, wherein the reaction layer has a density of 2.0 to 5.6 g/cm³.

5. The method of claim 1, wherein the reaction layer has a thickness of 5 to 30 μm.

6. The method of claim 1, wherein the second coating solution is applied so that the reaction layer has a linear, X-shaped, or cross (+)-shaped pattern.

7. The method of claim 1, wherein the ceramic coating layer is formed on an upper surface or a side surface of the separator substrate.

8. The method of claim 1, wherein the reaction layer is formed on an upper surface, a lower surface, or a side of the separator substrate.

9. A lithium secondary battery comprising:
a positive electrode;
a negative electrode; and
a separator interposed between the positive electrode and the negative electrode and having a coating layer containing a metal compound, the coating layer scattering X-rays and being formed on an edge portion of the separator which is not in contact with the positive electrode and the negative electrode.

10. The lithium secondary battery of claim 9, wherein the coating layer is formed on an upper surface or a side surface of the separator.

11. The lithium secondary battery of claim 9, wherein the metal compound has a density equal to or greater than 4.5 g/cm³.

12. The lithium secondary battery of claim 9, wherein the separator further includes:
a reaction layer formed to an edge portion of an upper surface of the coating layer which is not in contact with the positive electrode and the negative electrode, so that scatters the X-rays.

13. The method of claim 12, wherein the reaction layer is formed on an upper surface, a lower surface, or a side of a separator substrate of the separator.

14. The lithium secondary battery of claim 12, wherein the reaction layer has a density of 2.0 to 5.6 g/cm³.

15. The lithium secondary battery of claim 12, wherein the reaction layer has a thickness of 5 to 30 μm.

16. The lithium secondary battery of claim 12, wherein the reaction layer has a linear, X-shaped, or cross (+)-shaped pattern.
